(19) United States
(12) Patent Application Publication
(10) Pub. No.: US 2026/0126376 A1
(43) Pub. Date: May 7, 2026

(54) ULTRAVIOLET DIFFERENTIAL OPTICAL ABSORPTION SPECTROSCOPY (UV-DOAS) AND OPEN PATH (OP) BASED LONG-DISTANCE DETECTION DEVICE FOR CHLORINE GAS, AND METHOD

(71) Applicant: China Special Equipment Inspection & Research Institute, Beijing (CN)

(72) Inventors: Sheng CHEN, Beijing (CN); Yue YU, Beijing (CN); Dexin HOU, Beijing (CN); Guoshan XIE, Beijing (CN); Tonghua JIA, Beijing (CN); Tiantian LI, Beijing (CN); Guangxu CHENG, Beijing (CN); Bingjie WANG, Beijing (CN); Jipeng HAN, Beijing (CN); Zhixian LIU, Beijing (CN)

(73) Assignee: China Special Equipment Inspection & Research Institute, Beijing (CN)

(21) Appl. No.: 19/310,970

(22) Filed: Aug. 27, 2025

(30) Foreign Application Priority Data
Nov. 5, 2024 (CN) 202411562082.9

(51) Int. Cl. G01N 21/33; G01N 21/3504

(52) U.S. Cl. CPC G01N 21/33; G01N 21/3504

(57) ABSTRACT

An ultraviolet differential optical absorption spectroscopy (UV-DOAS) and open path (OP) based long-distance detection device for a chlorine gas, and a method are provided. A UV spectrometer is configured to generate a first absorption spectrogram for UV light, a second absorption spectrogram for collimated UV light penetrating an environmental gas, and a third absorption spectrogram for collimated UV light penetrating a to-be-detected chlorine gas; and a processor is configured to perform calculation on the spectrograms to obtain an absorption spectrogram for reference for concentration calculation, extract a characteristic parameter of the absorption spectrogram for reference for concentration calculation, and compare the characteristic parameter of the absorption spectrogram for reference for concentration calculation with a characteristic parameter of a standard absorption spectrogram for each of standard chlorine gases of different concentrations to determine a concentration of the to-be-detected chlorine gas.

### CROSS REFERENCE TO THE RELATED APPLICATIONS

This application is based upon and claims priority to Chinese Patent Application No. 202411562082.9, filed on Nov. 5, 2024, the entire contents of which are incorporated herein by reference.

### TECHNICAL FIELD

The present disclosure relates to the technical field of chlorine gas leakage detection, and in particular to an ultraviolet differential optical absorption spectroscopy (UV-DOAS) and open path (OP) based long-distance detection device for a chlorine gas, and a method.

### BACKGROUND

Chlorine gas is highly toxic and is a major hazard for dangerous chemicals. Its leakage detection has become a key industry focus, particularly in the chemical sector. Conventional detection using electrochemical sensors at fixed monitoring points is only limited to gas sampling around these monitoring points. It generally requires a relatively high gas concentration for detection and commonly suffers from a slow detection speed, a limited detection distance, a low sensitivity, and a susceptibility to failure for environmental interference. How to realize simultaneous, rapid, and high-sensitivity detection of the chlorine gas over a large-scale region is a critical safety challenge in production, storage, use and so on of the chlorine gas.

### SUMMARY

An objective of the present disclosure is to provide a UV-DOAS and OP based long-distance detection device for a chlorine gas, and a method, to realize simultaneous, rapid, and high-sensitivity detection of the chlorine gas over a large-scale region.

To achieve the above objective, the present disclosure provides the following technical solutions.

According to a first aspect, the present disclosure provides a UV-DOAS and OP based long-distance detection device for a chlorine gas. The UV-DOAS and OP based long-distance detection device for a chlorine gas includes: a UV light source, a UV focusing module, a reference gas cell module, a multi-point corner cube retroreflector (CCR) array, a UV spectrometer, and a processor, where
the UV light source is configured to generate UV light, and project the UV light to the UV focusing module and the UV spectrometer;
the UV focusing module is configured to focus the UV light, and project resulting collimated UV light to the reference gas cell module and the multi-point CCR array;
the reference gas cell module is filled with an environmental gas; and the reference gas cell module is configured to reflect the collimated UV light penetrating the environmental gas to the UV spectrometer;
a to-be-detected chlorine gas is located between the UV focusing module and the multi-point CCR array; and the multi-point CCR array is configured to reflect the collimated UV light penetrating the to-be-detected chlorine gas to the UV spectrometer;
the UV spectrometer is configured to generate a first absorption spectrogram for the UV light, a second absorption spectrogram for the collimated UV light penetrating the environmental gas, and a third absorption spectrogram for the collimated UV light penetrating the to-be-detected chlorine gas; and
the processor is in communication connection with the UV spectrometer; and the processor is configured to perform calculation on the first absorption spectrogram, the second absorption spectrogram, and the third absorption spectrogram to obtain an absorption spectrogram for reference for concentration calculation, extract a characteristic parameter of the absorption spectrogram for reference for concentration calculation, and compare the characteristic parameter of the absorption spectrogram for reference for concentration calculation with a characteristic parameter of a standard absorption spectrogram for each of standard chlorine gases of different concentrations to determine a concentration of the to-be-detected chlorine gas, where the characteristic parameter includes a waveform, a wavelength width, and a peak value of each absorption peak.

Optionally, the UV focusing module includes a main optical path mirror, an off-axis parabolic mirror, and a bypass optical path mirror;
the main optical path mirror is configured to reflect the UV light to the off-axis parabolic mirror;
the off-axis parabolic mirror is configured to focus the UV light, and project the resulting collimated UV light to the bypass optical path mirror or the multi-point CCR array; and
the bypass optical path mirror is configured to reflect the collimated UV light to the reference gas cell module.

Optionally, the reference gas cell module includes a reference gas cell, as well as a first UV filter and a reference gas cell retroreflector that are provided in the reference gas cell; the reference gas cell is filled with the environmental gas; the first UV filter is configured to filter the collimated UV light, and project filtered collimated UV light to the environmental gas; and the reference gas cell retroreflector is configured to reflect the collimated UV light penetrating the environmental gas to the UV spectrometer; and
the UV-DOAS and OP based long-distance detection device for a chlorine gas further includes: an UV filter module provided between the UV focusing module and the multi-point CCR array; the UV filter module includes a second UV filter; and the second UV filter is configured to filter the collimated UV light, and project filtered collimated UV light to the multi-point CCR array.

Optionally, the multi-point CCR array includes a plurality of CCR arrays located at different positions; the UV-DOAS and OP based long-distance detection device for a chlorine gas further includes: a multi-point angular adjustment mirror provided between the UV focusing module and the multi-point CCR array; and the multi-point angular adjustment mirror is configured to reflect the collimated UV light to a CCR array at a predetermined position, where the CCR array at the predetermined position is one CCR array of the CCR arrays at the different positions.

Optionally, the UV-DOAS and OP based long-distance detection device for a chlorine gas further includes: an auxiliary aiming module; and the auxiliary aiming module includes an infrared light source and an aiming telescope;
the infrared light source is configured to generate infrared light, and project the infrared light to the UV focusing module;
the UV focusing module is configured to focus the infrared light, and project resulting collimated infrared light to the multi-point angular adjustment mirror;
the multi-point angular adjustment mirror is configured to reflect the collimated infrared light to the multi-point CCR array; and
the aiming telescope is configured to observe whether the multi-point CCR array includes a red spot, so as to adjust a position of the multi-point angular adjustment mirror and a position of the multi-point CCR array.

Optionally, the UV-DOAS and OP based long-distance detection device for a chlorine gas further includes: an integrated fiber-optic transceiving module; and the integrated fiber-optic transceiving module is connected to the UV light source, the UV focusing module and the UV spectrometer;
the integrated fiber-optic transceiving module is configured to project the UV light generated by the UV light source to the UV focusing module and the UV spectrometer;
the reference gas cell retroreflector is configured to reflect the collimated UV light penetrating the environmental gas to the bypass optical path mirror; the bypass optical path mirror is configured to reflect the collimated UV light penetrating the environmental gas to the off-axis parabolic mirror; the off-axis parabolic mirror is configured to reflect the collimated UV light penetrating the environmental gas to the main optical path mirror; the main optical path mirror is configured to project the collimated UV light penetrating the environmental gas to the integrated fiber-optic transceiving module; and the integrated fiber-optic transceiving module is configured to project the collimated UV light penetrating the environmental gas to the UV spectrometer; and
the multi-point CCR array is configured to reflect the collimated UV light penetrating the to-be-detected chlorine gas to the second UV filter; the second UV filter is configured to project the collimated UV light penetrating the to-be-detected chlorine gas to the off-axis parabolic mirror; the off-axis parabolic mirror is configured to reflect the collimated UV light penetrating the to-be-detected chlorine gas to the main optical path mirror; the main optical path mirror is configured to project the collimated UV light penetrating the to-be-detected chlorine gas to the integrated fiber-optic transceiving module; and the integrated fiber-optic transceiving module is configured to project the collimated UV light penetrating the to-be-detected chlorine gas to the UV spectrometer.

Optionally, the UV filter module further includes an adjustment component; the adjustment component is in driving connection with the second UV filter; and the adjustment component is configured to adjust a position and an angle of the second UV filter, such that an optical path of reflected light of the collimated UV light projected to the second UV filter does not coincide with an optical path of the collimated UV light penetrating the to-be-detected chlorine gas and projected to the second UV filter.

Optionally, the reference gas cell module is filled with the standard chlorine gas;
the UV light source is configured to generate the UV light, and project the UV light to the UV focusing module and the UV spectrometer;
the UV focusing module is configured to focus the UV light, and project the resulting collimated UV light to the reference gas cell module;
the reference gas cell module is configured to reflect collimated UV light penetrating the standard chlorine gas to the UV spectrometer;
the UV spectrometer is configured to generate a fourth absorption spectrogram for the UV light and a fifth absorption spectrogram for the collimated UV light penetrating the standard chlorine gas; and
the processor is configured to perform calculation on the fourth absorption spectrogram and the fifth absorption spectrogram to obtain a calibration-reference absorption spectrogram, extract a characteristic parameter of the calibration-reference absorption spectrogram, and compare the characteristic parameter of the calibration-reference absorption spectrogram with the characteristic parameter of the standard absorption spectrogram for the standard chlorine gas to determine a characteristic parameter deviation caused by background noise.

According to a second aspect, the present disclosure provides a working method of a UV-DOAS and OP based long-distance detection device for a chlorine gas, applied to the UV-DOAS and OP based long-distance detection device for a chlorine gas, and including the following steps:
performing the calculation on the first absorption spectrogram, the second absorption spectrogram, and the third absorption spectrogram to obtain the absorption spectrogram for reference for concentration calculation; and
extracting the characteristic parameter of the absorption spectrogram for reference for concentration calculation, and comparing the characteristic parameter of the absorption spectrogram for reference for concentration calculation with the characteristic parameter of the standard absorption spectrogram for each of the standard chlorine gases of the different concentrations to determine the concentration of the to-be-detected chlorine gas, where the characteristic parameter includes the waveform, the wavelength width, and the peak value of each absorption peak.

Optionally, the performing the calculation on the first absorption spectrogram, the second absorption spectrogram, and the third absorption spectrogram to obtain the absorption spectrogram for reference for concentration calculation specifically includes: calculating a sum of the second absorption spectrogram and the third absorption spectrogram, and calculating a ratio of the first absorption spectrogram to the sum to obtain the absorption spectrogram for reference for concentration calculation; and alternatively, calculating a difference between the first absorption spectrogram and the second absorption spectrogram, and calculating another difference between the difference and the third absorption spectrogram to obtain the absorption spectrogram for reference for concentration calculation;
the extracting the characteristic parameter of the absorption spectrogram for reference for concentration calculation specifically includes: extracting the characteristic parameter of the absorption spectrogram for reference for concentration calculation with a convolutional neural network (CNN); and
the comparing the characteristic parameter of the absorption spectrogram for reference for concentration calculation with the characteristic parameter of the standard absorption spectrogram for each of the standard chlorine gases of the different concentrations specifically includes: making compensation for the characteristic parameter of the absorption spectrogram for reference for concentration calculation with the characteristic parameter deviation caused by the background noise to obtain a compensated characteristic parameter of the absorption spectrogram for reference for concentration calculation; and comparing the compensated characteristic parameter of the absorption spectrogram for reference for concentration calculation with the characteristic parameter of the standard absorption spectrogram for each of the standard chlorine gases of the different concentrations.

According to specific embodiments provided in the present disclosure, the present disclosure achieves the following technical effects:

According to the UV-DOAS and OP based long-distance detection device for a chlorine gas, and the method provided by the present disclosure, the UV light source is configured to generate UV light, and project the UV light to the UV focusing module and the UV spectrometer. The UV focusing module is configured to focus the UV light, and project resulting collimated UV light to the reference gas cell module and the multi-point CCR array. The reference gas cell is filled with the environmental gas module. The reference gas cell module is configured to reflect the collimated UV light penetrating the environmental gas to the UV spectrometer. The to-be-detected chlorine gas is located between the UV focusing module and the multi-point CCR array. The multi-point CCR array is configured to reflect the collimated UV light penetrating the to-be-detected chlorine gas to the UV spectrometer. The UV spectrometer is configured to generate a first absorption spectrogram for the UV light, a second absorption spectrogram for the collimated UV light penetrating the environmental gas, and a third absorption spectrogram for the collimated UV light penetrating the to-be-detected chlorine gas. The processor is configured to perform calculation on the first absorption spectrogram, the second absorption spectrogram, and the third absorption spectrogram to obtain an absorption spectrogram for reference for concentration calculation, extract a characteristic parameter of the absorption spectrogram for reference for concentration calculation, and compare the characteristic parameter of the absorption spectrogram for reference for concentration calculation with a characteristic parameter of a standard absorption spectrogram for each of standard chlorine gases of different concentrations to determine a concentration of the to-be-detected chlorine gas. The present disclosure makes use of light for detection. With advantages of the light in long propagation distance and fast propagation speed, the present disclosure can improve a detection distance and a detection speed in chlorine gas detection, realizing long-distance detection. Subsequently, the present disclosure determines the concentration of the chlorine gas in combination with the first absorption spectrogram for the UV light, the second absorption spectrogram for the collimated UV light penetrating the environmental gas, and the third absorption spectrogram for the collimated UV light penetrating the to-be-detected chlorine gas, and can eliminate influences from stray light and particulate matters (PMs) in the environment, improving detection precision of the chlorine gas detection, realizing the simultaneous, rapid, and high-sensitivity detection of the chlorine gas over the large-scale region, and solving the common problems of the slow detection speed, the limited detection distance, the low sensitivity, and the susceptibility to failure for environmental interference.

### BRIEF DESCRIPTION OF THE DRAWINGS

To describe the technical solutions in the embodiments of present disclosure or in the prior art more clearly, the following briefly describes the accompanying drawings required for the embodiments. Apparently, the accompanying drawings in the following description show merely some embodiments of present disclosure, and a person of ordinary skill in the art may still derive other accompanying drawings from these accompanying drawings without creative efforts.

FIG. 1 is a schematic structural view of a UV-DOAS and OP based long-distance detection device for a chlorine gas according to Embodiment 1 of the present disclosure; and

FIG. 2 is a schematic flowchart of a working method of a UV-DOAS and OP based long-distance detection device for a chlorine gas according to Embodiment 1 of the present disclosure.

Reference numerals: 1—housing, 2—mounting support, 3—integrated fiber-optic transceiving module, 4—UV spectrometer, 5—standard gas charging-discharging port, 6—UV light source, 7—infrared light source, 8—reference gas cell retroreflector, 9—environmental gas charging-discharging port, 10—reference gas cell, 11—first UV filter, 12—off-axis parabolic mirror, 13—aiming telescope, 14—main optical path mirror, 15—bypass optical path mirror, 16—second UV filter, 17—multi-point angular adjustment mirror, and 18—CCR array.

### DETAILED DESCRIPTION OF THE EMBODIMENTS

The technical solutions in the embodiments of present disclosure are clearly and completely described below with reference to the drawings in the embodiments of present disclosure. Apparently, the described embodiments are only some rather than all of the embodiments of present disclosure. All other embodiments obtained by a person of ordinary skill in the art based on the embodiments of the utility model without creative efforts shall fall within the protection scope of the utility model.

### Embodiment 1

At present, there haven't been long-distance OP detection devices. Some studies propose to make use of a UV-DOAS in the atmospheric monitoring field to detect such gases as SO₂ and NO₂, but this approach cannot realize OP detection. Some studies propose to detect a chlorine gas in a closed path (CP) with a gas-cell UV-DOAS, but this approach also cannot realize the OP detection. Therefore, research on chlorine gas detection with the UV-DOAS and the OP remains blank.

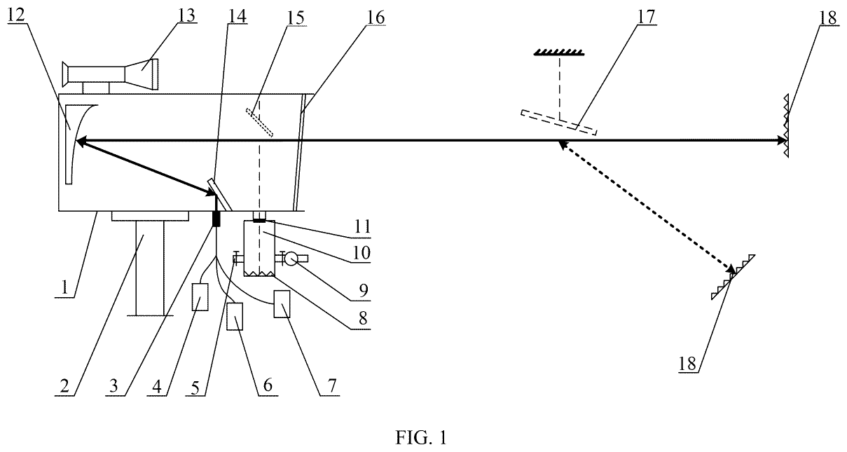

In view of this, the embodiment provides a UV-DOAS and OP based long-distance detection device for a chlorine gas. As shown in FIG. 1, the UV-DOAS and OP based long-distance detection device for a chlorine gas includes: a UV light source 6, a UV focusing module, a reference gas cell module, a multi-point CCR array, a UV spectrometer 4, and a processor.

The UV light source 6 is configured to generate UV light, and project the UV light to the UV focusing module and the UV spectrometer 4.

The UV focusing module is configured to focus the UV light, and project resulting collimated UV light to the reference gas cell module and the multi-point CCR array.

The reference gas cell module is filled with an environmental gas. The reference gas cell module is configured to reflect the collimated UV light penetrating the environmental gas to the UV spectrometer 4.

A to-be-detected chlorine gas is located between the UV focusing module and the multi-point CCR array. The multi-point CCR array is configured to reflect the collimated UV light penetrating the to-be-detected chlorine gas to the UV spectrometer 4.

The UV spectrometer 4 is configured to generate a first absorption spectrogram for the UV light, a second absorption spectrogram for the collimated UV light penetrating the environmental gas, and a third absorption spectrogram for the collimated UV light penetrating the to-be-detected chlorine gas.

The processor is in communication connection with the UV spectrometer 4. The processor is configured to perform calculation on the first absorption spectrogram, the second absorption spectrogram, and the third absorption spectrogram to obtain an absorption spectrogram for reference for concentration calculation, extract a characteristic parameter of the absorption spectrogram for reference for concentration calculation, and compare the characteristic parameter of the absorption spectrogram for reference for concentration calculation with a characteristic parameter of a standard absorption spectrogram for each of standard chlorine gases of different concentrations to determine a concentration of the to-be-detected chlorine gas. The characteristic parameter includes a waveform, a wavelength width, and a peak value of each absorption peak.

According to the embodiment, with the use of the OP, the collimated UV light exited from the UV focusing module is projected to the reference gas cell module and the multi-point CCR array to respectively detect the environmental gas and the to-be-detected chlorine gas. The embodiment makes use of light for detection. With advantages of the light in long propagation distance and fast propagation speed, the embodiment can improve a detection distance and a detection speed in chlorine gas detection, realizing long-distance detection. Subsequently, the present disclosure determines the concentration of the chlorine gas in combination with the first absorption spectrogram for the UV light, the second absorption spectrogram for the collimated UV light penetrating the environmental gas, and the third absorption spectrogram for the collimated UV light penetrating the to-be-detected chlorine gas, and can eliminate influences from stray light and PMs in the environment based on the UV-DOAS, improving detection precision of the chlorine gas detection, realizing the simultaneous, rapid, and high-sensitivity detection of the chlorine gas over the large-scale region, and solving the common problems of the slow detection speed, the limited detection distance, the low sensitivity, and the susceptibility to failure for environmental interference.

In the embodiment, the UV light source 6 employs a xenon flash lamp to generate pulsed UV light at a high frequency of 1-1,000 times/min, with an optical output power not less than 100 MW. Its wavelength is 220-2,200 nm, encompassing the wavelength of UV light to the wavelength of visible light. When the chlorine gas is detected, the wavelength of the UV light source is selected to 6 200-400 nm.

In the embodiment, the UV focusing module includes a main optical path mirror 14, an off-axis parabolic mirror 12, and a bypass optical path mirror 15.

The main optical path mirror 14 is configured to reflect the UV light to the off-axis parabolic mirror 12.

The off-axis parabolic mirror 12 is configured to focus the UV light, and project the resulting collimated UV light to the bypass optical path mirror 15 or the multi-point CCR array.

The bypass optical path mirror 15 is configured to reflect the collimated UV light to the reference gas cell module.

The UV light emitted from the UV light source 6 is reflected by the main optical path mirror 14 to the off-axis parabolic mirror 12, and collected near a focal point of the off-axis parabolic mirror 12 to form the collimated UV light to be exit. When the environmental gas is to be detected, the bypass optical path mirror 15 is moved to a position between the off-axis parabolic mirror 12 and the multi-point CCR array. The off-axis parabolic mirror 12 is configured to directly project the collimated UV light to the bypass optical path mirror 15. The bypass optical path mirror 15 is configured to reflect the collimated UV light to the reference gas cell module. When the to-be-detected chlorine gas is to be detected, the off-axis parabolic mirror 12 is configured to directly project the collimated UV light to the multi-point CCR array.

The off-axis parabolic mirror 12 is plated with a UV-enhanced aluminum film, with an off-axis angle of 0-30°, a focal length of 300-1,000 mm, and a diameter of 100-400 mm. The bypass optical path mirror 15 is a 45° plane mirror whose diameter is 10-100 mm.

In the embodiment, the reference gas cell module includes a reference gas cell 10, as well as a first UV filter 11 and a reference gas cell retroreflector 8 that are provided in the reference gas cell 10.

The reference gas cell 10 is filled with the environmental gas.

The first UV filter 11 is configured to filter the collimated UV light, and project filtered collimated UV light to the environmental gas.

The reference gas cell retroreflector 8 is configured to reflect the collimated UV light penetrating the environmental gas to the UV spectrometer 4.

In actual detection on the chlorine gas, the reference gas cell module is configured to detect interference of stray light or PMs on an absorption spectrum and an absorption intensity of the chlorine gas in real time in the environment. By this time, the collimated UV light exited from the off-axis parabolic mirror 12 is projected to the bypass optical path mirror 15, and reflected to the reference gas cell 10 by deflecting 90°. The first UV filter 11 is provided at an inlet of the reference gas cell 10, with a transmission wavelength of 180-550 nm. After filtered by the first UV filter 11, the collimated UV light is projected to the environmental gas in the reference gas cell 10. Through the reference gas cell retroreflector 8, the collimated UV light is reflected in the reference gas cell 10 once or repeatedly. The collimated UV light penetrating the environmental gas is reflected to the UV spectrometer 4.

The concentration measurement in the embodiment is realized based on the Beer-Lambert Law. The Beer-Lambert Law is a law for describing a relationship among the absorption intensity of the substance to light at a certain wavelength, the concentration of the light-absorbing substance and the thickness of the liquid layer. Due to a fixed physical length of the reference gas cell 10, if the collimated UV light is only transmitted once in the reference gas cell 10, the attenuation effect is relatively small. Hence, the reference gas cell retroreflector 8 is provided in the embodiment. By adjusting a position of the reference gas cell retroreflector 8, the collimated UV light is reflected once or repeatedly in the reference gas cell 10 and then exited. This can increases the attenuation effect, and reduce the error. Specifically, the reference gas cell retroreflector 8 may be provided at a bottom of the reference gas cell 10.

In the embodiment, the UV-DOAS and OP based long-distance detection device for a chlorine gas further includes: an UV filter module provided between the UV focusing module and the multi-point CCR array. The UV filter module includes a second UV filter 16. The second UV filter 16 is a filter lens, and is located between the off-axis parabolic mirror 12 and a collimated UV light outlet, with a transmission wavelength of 180-550 nm. The second UV filter 16 is configured to filter the collimated UV light, and project filtered collimated UV light to the multi-point CCR array.

In the embodiment, the multi-point CCR array includes a plurality of CCR arrays 18 located at different positions. The CCR array 18 is an array composed of a plurality of CCRs. In order to detect the chlorine gas at different positions, namely realize detection on the chlorine gas at a plurality of positions, in the embodiment, the UV-DOAS and OP based long-distance detection device for a chlorine gas further includes: a multi-point angular adjustment mirror 17 provided between the UV focusing module and the multi-point CCR array. When the UV filter module is provided, the multi-point angular adjustment mirror 17 for rotationally adjusting an angle accurately and automatically is additionally provided at any position between the UV filter module and the multi-point CCR array. The multi-point angular adjustment mirror 17 is configured to reflect the collimated UV light to a CCR array 18 at a predetermined position by adjusting an own angle. The CCR array 18 at the predetermined position is one CCR array 18 of the CCR arrays 18 at the different positions. That is, the exited collimated UV light is refracted by a certain angle to reach different CCR arrays 18, thereby realizing spatial multi-point measurement on the concentration of the chlorine gas.

Preferably, the to-be-detected chlorine gas is located between the multi-point angular adjustment mirror 17 and the multi-point CCR array, and an average concentration of the to-be-detected chlorine gas between the multi-point angular adjustment mirror 17 and the multi-point CCR array can be measured.

In the embodiment, the UV-DOAS and OP based long-distance detection device for a chlorine gas further includes: an integrated fiber-optic transceiving module 3. The integrated fiber-optic transceiving module 3 is connected to the UV light source 6, the UV focusing module and the UV spectrometer 4. The integrated fiber-optic transceiving module 3 may employ a 7-core Y-type fiber, in which the central one Y-type fiber is a UV-resistant fiber with a diameter of 100-400 μm and is a central receiving fiber, and peripheral six Y-type fibers are transmitting fibers. The peripheral transmitting fibers are uniformly distributed in a circular ring. A distance from a center of the peripheral transmitting fiber to a center of the central receiving fiber is 200-2,000 μm.

The integrated fiber-optic transceiving module 3 is configured to project the UV light generated by the UV light source 6 to the UV focusing module and the UV spectrometer 4. By this time, the UV light generated by the UV light source 6 is projected after fiber coupling.

The reference gas cell retroreflector 8 is configured to reflect the collimated UV light penetrating the environmental gas to the bypass optical path mirror 15. The bypass optical path mirror 15 is configured to reflect the collimated UV light penetrating the environmental gas to the off-axis parabolic mirror 12. The off-axis parabolic mirror 12 is configured to reflect the collimated UV light penetrating the environmental gas to the main optical path mirror 14. The main optical path mirror 14 is configured to project the collimated UV light penetrating the environmental gas to the integrated fiber-optic transceiving module 3. The integrated fiber-optic transceiving module 3 is configured to project the collimated UV light penetrating the environmental gas to the UV spectrometer 4. By this time, the collimated UV light penetrating the environmental gas exited from the reference gas cell retroreflector 8 is reflected to the bypass optical path mirror 15. After reflected by the bypass optical path mirror 15 and the off-axis parabolic mirror 12 again, it enters the integrated fiber-optic transceiving module 3, and is coupled by the central receiving fiber of the integrated fiber-optic transceiving module 3 and transmitted to the UV spectrometer 4, eliminating the external environmental interference.

The multi-point CCR array is configured to reflect the collimated UV light penetrating the to-be-detected chlorine gas to the second UV filter 16. The second UV filter 16 is configured to project the collimated UV light penetrating the to-be-detected chlorine gas to the off-axis parabolic mirror 12. The off-axis parabolic mirror 12 is configured to reflect the collimated UV light penetrating the to-be-detected chlorine gas to the main optical path mirror 14. The main optical path mirror 14 is configured to project the collimated UV light penetrating the to-be-detected chlorine gas to the integrated fiber-optic transceiving module 3. The integrated fiber-optic transceiving module 3 is configured to project the collimated UV light penetrating the to-be-detected chlorine gas to the UV spectrometer 4. By this time, the collimated UV light exited from the off-axis parabolic mirror 12 is filtered by the UV filter module to reach the CCR array 18 at a distal end, bounced back, and then focused at the off-axis parabolic mirror 12 through the UV filter module. After reflected by the main optical path mirror 14, the focused the collimated UV light penetrating the to-be-detected chlorine gas is coupled by the central receiving fiber of the integrated fiber-optic transceiving module 3 and transmitted to the UV spectrometer 4.

In the embodiment, the UV filter module further includes an adjustment component. The adjustment component is in driving connection with the second UV filter 16. The adjustment component is configured to adjust a position and an angle of the second UV filter 16, such that an optical path of reflected light of the collimated UV light projected to the second UV filter 16 does not coincide with an optical path of the collimated UV light penetrating the to-be-detected chlorine gas and projected to the second UV filter 16.

In order to reduce the device length, and provide a capability for adjusting a position of the light source, the second UV filter 16 is fixed on a three-degrees-of-freedom (3-DOF) adjustment table to achieve two tilt angle adjustment capabilities and a front-back translation adjustment capability. FIG. 1 shows an x-z plane. The two tilt angle adjustment capabilities in the embodiment include an angular adjustment capability in the x-z plane and an angular adjustment capability in a y-z plane. The 3-DOF coordinate position of the light emitting point is changed equivalently, and the angular adjustment range is 0-30°. In the embodiment, the adjustment capability is essential, since an actual processed focal length of the off-axis parabolic mirror 12 has an allowable error of ±1%, and the best light emitting position is not fittingly located at the focal point. The collimated UV light exited from the off-axis parabolic mirror 12 is reflected and transmitted at the second UV filter 16. To prevent reflected light (about 5% of the light intensity) of the exited collimated UV light at the second UV filter 16 from interfering the collimated UV light penetrating the to-be-detected chlorine gas reflected to the second UV filter 16, the second UV filter 16 is adjusted by a certain angle, and thus the reflected light is deviated.

In the embodiment, the UV-DOAS and OP based long-distance detection device for a chlorine gas further includes: an auxiliary aiming module. The auxiliary aiming module includes an infrared light source 7 and an aiming telescope 13. The infrared light source 7 is connected to the integrated fiber-optic transceiving module 3.

The infrared light source 7 is configured to generate infrared light, and project the infrared light to the UV focusing module.

The UV focusing module is configured to focus the infrared light, and project resulting collimated infrared light to the multi-point angular adjustment mirror 17.

The multi-point angular adjustment mirror 17 is configured to reflect the collimated infrared light to the multi-point CCR array.

The aiming telescope 13 is configured to observe whether the multi-point CCR array includes a red spot, so as to adjust a position of the multi-point angular adjustment mirror 17 and a position of the multi-point CCR array to ensure correct propagation of the optical path.

The auxiliary aiming module includes the auxiliary infrared light source 7 and the aiming telescope 13. The infrared light emitted from the infrared light source 7 is visible laser. The infrared light source 7 may be a red laser emitter, with an optical output power not less than 100 MW. After the device is mounted, and before the device starts to work, the UV light source 6 is switched to the infrared light source 7, such that the red spot can be seen at the multi-point CCR array. According to a position of the red spot, the multi-point angular adjustment mirror 17 and the multi-point CCR array are mounted and fixed well, which greatly reduces the aiming difficulty. The aiming telescope 13 is configured to observe the position of the red spot distantly, and assist to adjust a pose, such that the red spot is projected to a predetermined region. When the UV filter module is provided, the auxiliary aiming module may further be configured to adjust a position of the second UV filter 16 simultaneously, causing the optical path to be satisfactory.

The reference gas cell module makes use of the environmental gas to eliminate the environmental interference on one hand, and makes use of the standard gas (namely the standard chlorine gas) to calibrate the measuring precision of the device on the other hand. Therefore, the reference gas cell module includes a standard gas charging-discharging port 5 and an environmental gas charging-discharging port 9. The standard gas charging-discharging port 5 is configured to charge the standard chlorine gas to the reference gas cell 10 or discharge the standard chlorine gas from the reference gas cell 10. The environmental gas charging-discharging port 9 is configured to charge the environmental gas to the reference gas cell 10 or discharge the environmental gas from the reference gas cell 10.

In calibration, the reference gas cell module is filled with the standard chlorine gas.

The UV light source 6 is configured to generate the UV light, and project the UV light to the UV focusing module and the UV spectrometer 4.

The UV focusing module is configured to focus the UV light, and project the resulting collimated UV light to the reference gas cell module.

The reference gas cell module is configured to reflect collimated UV light penetrating the standard chlorine gas to the UV spectrometer 4.

The UV spectrometer 4 is configured to generate a fourth absorption spectrogram for the UV light and a fifth absorption spectrogram for the collimated UV light penetrating the standard chlorine gas.

The processor is configured to perform calculation on the fourth absorption spectrogram and the fifth absorption spectrogram to obtain a calibration-reference absorption spectrogram, extract a characteristic parameter of the calibration-reference absorption spectrogram, and compare the characteristic parameter of the calibration-reference absorption spectrogram with the characteristic parameter of the standard absorption spectrogram for the standard chlorine gas to determine a characteristic parameter deviation caused by background noise.

For the standard chlorine gas of each concentration, the above process is repeated. A difference between the characteristic parameter of the calibration-reference absorption spectrogram and the characteristic parameter of the standard absorption spectrogram for the standard chlorine gas is calculated to obtain the characteristic parameter deviation for the standard chlorine gas of each concentration. The characteristic parameter deviation for the standard chlorine gas of each concentration is averaged to obtain the final characteristic parameter deviation caused by the background noise.

In the embodiment, the UV spectrometer 4 has a measurement range of 150-500 nm, and a spectral resolution not greater than 5 nm. The first absorption spectrogram, the second absorption spectrogram, the third absorption spectrogram, the fourth absorption spectrogram, the fifth absorption spectrogram and the standard absorption spectrogram each show peak intensities corresponding to different wavelengths. The peak intensity may also be referred to as an absorption sectional area, with a unit being an amount of the chlorine gas in unit area and unit molar weight.

The UV light source 6 is configured to emit the UV light in a specific range. An intensity and a waveform signal of to-be-emitted UV light, an intensity and a waveform signal of the collimated UV light penetrating the environmental gas obtained after emitted UV light is absorbed by the environmental gas in a reference optical path length (OPL), and an intensity and a wave signal of the collimated UV light penetrating the to-be-detected chlorine gas obtained after the emitted UV light is absorbed by the to-be-detected chlorine gas in the reference OPL are measured to obtain the first absorption spectrogram, the second absorption spectrogram and the third absorption spectrogram, eliminating interference from the stray light and the PMs in the environment. A CNN is employed to invert the concentration of the chlorine gas to ensure high-precision inversion on the concentration of the chlorine gas.

The processor (which may also be referred to as a data storage and processing module) is configured to extract and store a characteristic parameter of an UV absorption spectrogram. Standard chlorine gases of different concentrations are employed in advance. A correlation between the characteristic parameter and the concentration of the chlorine gas is calibrated based on an experiment. Concentration inversion is performed based on the CNN and an image recognition method. Specifically, a standard absorption spectrogram for each of the standard chlorine gases of the different concentrations is acquired through the experiment. A characteristic parameter of the standard absorption spectrogram, namely a waveform, a wavelength width (namely a wavelength range covered by the absorption peak), a peak value and the like of each absorption peak, is extracted through the CNN. Calibration is performed to obtain a characteristic parameter of the standard absorption spectrogram for each of the standard chlorine gases of the different concentrations. The characteristic parameter of the acquired absorption spectrogram for reference for concentration calculation is extracted with the CNN, and compared with the characteristic parameter of the standard absorption spectrogram for each of the standard chlorine gases of the different concentrations, thereby realizing the concentration inversion.

The working method of the device in the embodiment is critical to ensure long-distance, high-precision and rapid measurement on the chlorine gas leakage. The core of the working method is to calibrate the law and correlation of the background noise of the device through the standard chlorine gases of the different concentrations. This eliminates influences from the background noise through subtraction for zero calibration on one hand, and establishes the correlation between the characteristic parameter and the concentration of the chlorine gas on the other hand. Then, in actual OP measurement, by reflecting and receiving the UV light with the multi-point CCR array, the third absorption spectrogram is obtained. By adjusting the bypass optical path mirror 15, extracting an actual atmospheric environmental gas with the reference gas cell 10, and synchronously measuring influences of the PMs in the atmospheric environmental gas on the measured intensity, the second absorption spectrogram is obtained, thereby eliminating the interference from the PMs in the environment. With the CNN and the image recognition method, high-precision inversion on the concentration of the chlorine gas is realized, with the minimum sensitivity not higher than 30 parts per billion (ppb).

When the concentration of the chlorine gas is measured, since the absorption spectrogram and the absorption intensity of the chlorine gas are affected by the PMs in the atmosphere, the UV light is projected to the reference gas cell 10 at regular intervals, such as 30 s, to measure influences for a content of PMs in the environment.

In the embodiment, a chlorine gas leakage detection device with a long distance of 200 m and a minimum sensitivity of 30 ppb is specifically designed. The UV light source 6 has a frequency of 1-600 times/min, an optical output power of 100-1,000 MW, and a wavelength of 200-2,000 nm. For the integrated fiber-optic transceiving module 3, the central receiving fiber has a diameter of 100-300 μm, and a distance from a center of the peripheral transmitting fiber to a center of the central receiving fiber is 200-1,800 μm. The off-axis parabolic mirror 12 has an off-axis angle of 0-25°, a focal length of 300-800 mm, and a diameter of 100-300 mm. The bypass optical path mirror 15 is a 45° plane mirror whose diameter is 10-100 mm. The first UV filter 11 has a transmission wavelength of 200-500 nm. The second UV filter 16 has a transmission wavelength of 200-500 nm, and an angular adjustment range of 0-20°. The UV spectrometer 4 has a measurement range of 150-500 nm, and a spectral resolution not greater than 3 nm. The infrared light source 7 has an optical output power of 400-1,000 MW.

In the embodiment, the UV-DOAS and OP based long-distance detection device for a chlorine gas further includes a housing 1 and a mounting support 2. Both the UV focusing module and the UV filter module are located in the housing 1. The mounting support 2 is configured to support the housing 1. The UV light source 6 and the reference gas cell module are located at a bottom of the housing 1. The aiming telescope 13 is located at a top of the housing 1.

In the embodiment, for the safety risk monitoring and pre-warning field of dangerous chemicals, the UV-DOAS and OP based long-distance detection device for a chlorine gas is developed. With special designs such as the high-frequency pulsed UV light source, the UV focusing module, the reference OPL (the atmospheric environmental gas at a monitoring position is extracted in real time through the reference gas cell 10, and influences of the PMs on the absorption spectrum of the chlorine gas are measured in an enclosed environment), the precise light splitter (which includes the multi-point angular adjustment mirror 17 and the multi-point CCR array to realize accurate focusing for a plurality of measuring positions), and the de-noising algorithm (the influences from the background noise are eliminated by subtraction for zero calibration), and the concentration inversion method (the correlation between the characteristic parameter and the concentration of the chlorine gas), the long-distance and high-precision quantized perception and pre-warning for chlorine gas leakage can be realized, the high-precision measurement with the long distance of 200 m or more and a ppb-level concentration of the chlorine gas and rapid pre-warning can be realized, the difficult problems of slow measurement for the highly toxic chlorine gas medium, high risk for people in close-distance measurement, and insufficient precision of the existing electrochemical/catalytic combustion method are effectively solved, and the full-chain risk pre-warning and safety control in production, storage and use of the chlorine gas are accomplished.

### Embodiment 2

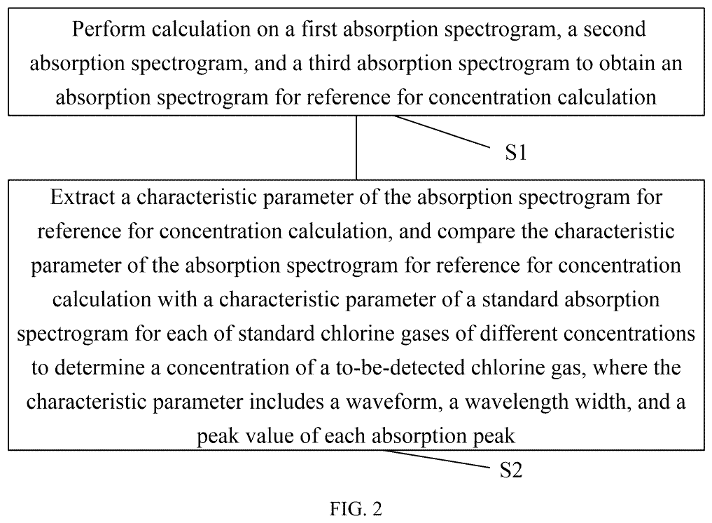

The embodiment provides a working method of a UV-DOAS and OP based long-distance detection device for a chlorine gas, which is applied to the UV-DOAS and OP based long-distance detection device for a chlorine gas in Embodiment 1. As shown in FIG. 2, the working method of a UV-DOAS and OP based long-distance detection device for a chlorine gas includes the following steps:
S1: The calculation is performed on the first absorption spectrogram, the second absorption spectrogram, and the third absorption spectrogram to obtain the absorption spectrogram for reference for concentration calculation.
S2: The characteristic parameter of the absorption spectrogram for reference for concentration calculation is extracted, and the characteristic parameter of the absorption spectrogram for reference for concentration calculation is compared with the characteristic parameter of the standard absorption spectrogram for each of the standard chlorine gases of the different concentrations to determine the concentration of the to-be-detected chlorine gas. The characteristic parameter includes the waveform, the wavelength width, and the peak value of each absorption peak.

The step that the calculation is performed on the first absorption spectrogram, the second absorption spectrogram, and the third absorption spectrogram to obtain the absorption spectrogram for reference for concentration calculation specifically includes: A sum of the second absorption spectrogram and the third absorption spectrogram is calculated, and a ratio of the first absorption spectrogram to the sum is calculated to obtain the absorption spectrogram for reference for concentration calculation. Alternatively, a difference between the first absorption spectrogram and the second absorption spectrogram is calculated, and another difference between the difference and the third absorption spectrogram is calculated to obtain the absorption spectrogram for reference for concentration calculation.

The step that the characteristic parameter of the absorption spectrogram for reference for concentration calculation is extracted specifically includes: The characteristic parameter of the absorption spectrogram for reference for concentration calculation is extracted with the CNN.

The step that the characteristic parameter of the absorption spectrogram for reference for concentration calculation is compared with the feature parameter of the standard absorption spectrogram for each of the standard chlorine gases of the different concentrations specifically includes: Compensation is made for the characteristic parameter of the absorption spectrogram for reference for concentration calculation with the characteristic parameter deviation caused by the background noise to obtain a compensated characteristic parameter of the absorption spectrogram for reference for concentration calculation. The compensated characteristic parameter of the absorption spectrogram for reference for concentration calculation is compared with the characteristic parameter of the standard absorption spectrogram for each of the standard chlorine gases of the different concentrations.

The technical features of the above embodiments can be employed in arbitrary combinations. To provide a concise description of these embodiments, all possible combinations of all the technical characteristics of the above embodiments may not be described. However, these combinations of the technical features should be construed as falling within the scope defined by the specification as long as no contradiction occurs.

Several examples are used herein for illustration of the principles and implementations of present disclosure. The description of the foregoing embodiment is used to help illustrate the method of present disclosure and the core principles thereof. In addition, those of ordinary skill in the art can make various modifications in terms of specific implementations and scope of application in accordance with the teachings of present disclosure. In conclusion, the content of the present specification shall not be construed as a limitation to present disclosure.

What is claimed is:

1. An ultraviolet differential optical absorption spectroscopy (UV-DOAS) and open path (OP) based long-distance detection device for a chlorine gas, comprising: an ultraviolet (UV) light source, a UV focusing module, a reference gas cell module, a multi-point corner cube retroreflector (CCR) array, a UV spectrometer, and a processor, wherein
the UV light source is configured to generate UV light, and project the UV light to the UV focusing module and the UV spectrometer;
the UV focusing module is configured to focus the UV light, and project resulting collimated UV light to the reference gas cell module and the multi-point CCR array;
the reference gas cell module is filled with an environmental gas; and the reference gas cell module is configured to reflect collimated UV light penetrating the environmental gas to the UV spectrometer;
a to-be-detected chlorine gas is located between the UV focusing module and the multi-point CCR array; and the multi-point CCR array is configured to reflect collimated UV light penetrating the to-be-detected chlorine gas to the UV spectrometer;
the UV spectrometer is configured to generate a first absorption spectrogram for the UV light, a second absorption spectrogram for the collimated UV light penetrating the environmental gas, and a third absorption spectrogram for the collimated UV light penetrating the to-be-detected chlorine gas; and
the processor is in communication connection with the UV spectrometer; and the processor is configured to perform calculation on the first absorption spectrogram, the second absorption spectrogram, and the third absorption spectrogram to obtain an absorption spectrogram for reference for concentration calculation, extract a characteristic parameter of the absorption spectrogram for reference for concentration calculation, and compare the characteristic parameter of the absorption spectrogram for reference for concentration calculation with a characteristic parameter of a standard absorption spectrogram for each of standard chlorine gases of different concentrations to determine a concentration of the to-be-detected chlorine gas, wherein the characteristic parameter comprises a waveform, a wavelength width, and a peak value of each absorption peak.

2. The UV-DOAS and OP based long-distance detection device for the chlorine gas according to claim 1, wherein the UV focusing module comprises a main optical path mirror, an off-axis parabolic mirror, and a bypass optical path mirror;
the main optical path mirror is configured to reflect the UV light to the off-axis parabolic mirror;
the off-axis parabolic mirror is configured to focus the UV light, and project the resulting collimated UV light to the bypass optical path mirror or the multi-point CCR array; and
the bypass optical path mirror is configured to reflect the resulting collimated UV light to the reference gas cell module.

3. The UV-DOAS and OP based long-distance detection device for the chlorine gas according to claim 2, wherein the reference gas cell module comprises a reference gas cell, a first UV filter, and a reference gas cell retroreflector, wherein the first UV filter and the reference gas cell retroreflector are provided in the reference gas cell; the reference gas cell is filled with the environmental gas; the first UV filter is configured to filter the resulting collimated UV light, and project first filtered collimated UV light to the environmental gas; and the reference gas cell retroreflector is configured to reflect the collimated UV light penetrating the environmental gas to the UV spectrometer; and
the UV-DOAS and OP based long-distance detection device for the chlorine gas further comprises: an UV filter module provided between the UV focusing module and the multi-point CCR array; the UV filter module comprises a second UV filter; and the second UV filter is configured to filter the resulting collimated UV light, and project second filtered collimated UV light to the multi-point CCR array.

4. The UV-DOAS and OP based long-distance detection device for the chlorine gas according to claim 1, wherein the multi-point CCR array comprises a plurality of CCR arrays located at different positions; the UV-DOAS and OP based long-distance detection device for the chlorine gas further comprises: a multi-point angular adjustment mirror provided between the UV focusing module and the multi-point CCR array; and the multi-point angular adjustment mirror is configured to reflect the resulting collimated UV light to a CCR array at a predetermined position, wherein the CCR array at the predetermined position is a CCR array of the plurality of CCR arrays located at the different positions.

5. The UV-DOAS and OP based long-distance detection device for the chlorine gas according to claim 4, further comprising an auxiliary aiming module; wherein the auxiliary aiming module comprises an infrared light source and an aiming telescope;
the infrared light source is configured to generate infrared light, and project the infrared light to the UV focusing module;
the UV focusing module is configured to focus the infrared light, and project resulting collimated infrared light to the multi-point angular adjustment mirror;
the multi-point angular adjustment mirror is configured to reflect the collimated infrared light to the multi-point CCR array; and
the aiming telescope is configured to observe whether the multi-point CCR array comprises a red spot to adjust a position of the multi-point angular adjustment mirror and a position of the multi-point CCR array.

6. The UV-DOAS and OP based long-distance detection device for the chlorine gas according to claim 3, further comprising an integrated fiber-optic transceiving module; wherein the integrated fiber-optic transceiving module is connected to the UV light source, the UV focusing module, and the UV spectrometer;
the integrated fiber-optic transceiving module is configured to project the UV light generated by the UV light source to the UV focusing module and the UV spectrometer;
the reference gas cell retroreflector is configured to reflect the collimated UV light penetrating the environmental gas to the bypass optical path mirror; the bypass optical path mirror is configured to reflect the collimated UV light penetrating the environmental gas to the off-axis parabolic mirror; the off-axis parabolic mirror is configured to reflect the collimated UV light penetrating the environmental gas to the main optical path mirror; the main optical path mirror is configured to project the collimated UV light penetrating the environmental gas to the integrated fiber-optic transceiving module; and the integrated fiber-optic transceiving module is configured to project the collimated UV light penetrating the environmental gas to the UV spectrometer; and
the multi-point CCR array is configured to reflect the collimated UV light penetrating the to-be-detected chlorine gas to the second UV filter; the second UV filter is configured to project the collimated UV light penetrating the to-be-detected chlorine gas to the off-axis parabolic mirror; the off-axis parabolic mirror is configured to reflect the collimated UV light penetrating the to-be-detected chlorine gas to the main optical path mirror; the main optical path mirror is configured to project the collimated UV light penetrating the to-be-detected chlorine gas to the integrated fiber-optic transceiving module; and the integrated fiber-optic transceiving module is configured to project the collimated UV light penetrating the to-be-detected chlorine gas to the UV spectrometer.

7. The UV-DOAS and OP based long-distance detection device for the chlorine gas according to claim 6, wherein the UV filter module further comprises an adjustment component; the adjustment component is in driving connection with the second UV filter; and the adjustment component is configured to adjust a position of the second UV filter and an angle of the second UV filter, such that an optical path of reflected light of the resulting collimated UV light projected to the second UV filter does not coincide with an optical path of the collimated UV light penetrating the to-be-detected chlorine gas and projected to the second UV filter.

8. The UV-DOAS and OP based long-distance detection device for the chlorine gas according to claim 1, wherein the reference gas cell module is filled with the standard chlorine gas;
the UV light source is configured to generate the UV light, and project the UV light to the UV focusing module and the UV spectrometer;
the UV focusing module is configured to focus the UV light, and project the resulting collimated UV light to the reference gas cell module;
the reference gas cell module is configured to reflect collimated UV light penetrating the standard chlorine gas to the UV spectrometer;
the UV spectrometer is configured to generate a fourth absorption spectrogram for the UV light and a fifth absorption spectrogram for the collimated UV light penetrating the standard chlorine gas; and
the processor is configured to perform calculation on the fourth absorption spectrogram and the fifth absorption spectrogram to obtain a calibration-reference absorption spectrogram, extract a characteristic parameter of the calibration-reference absorption spectrogram, and compare the characteristic parameter of the calibration-reference absorption spectrogram with the characteristic parameter of the standard absorption spectrogram for the standard chlorine gas to determine a characteristic parameter deviation caused by background noise.

9. A working method of a UV-DOAS and OP based long-distance detection device for a chlorine gas, applied to the UV-DOAS and OP based long-distance detection device for the chlorine gas according to claim 1, and comprising the following steps:
performing the calculation on the first absorption spectrogram, the second absorption spectrogram, and the third absorption spectrogram to obtain the absorption spectrogram for reference for concentration calculation; and
extracting the characteristic parameter of the absorption spectrogram for reference for concentration calculation, and comparing the characteristic parameter of the absorption spectrogram for reference for concentration calculation with the characteristic parameter of the standard absorption spectrogram for each of the standard chlorine gases of the different concentrations to determine the concentration of the to-be-detected chlorine gas, wherein the characteristic parameter comprises the waveform, the wavelength width, and the peak value of each absorption peak.

10. The working method of the UV-DOAS and OP based long-distance detection device for the chlorine gas according to claim 9, wherein the performing the calculation on the first absorption spectrogram, the second absorption spectrogram, and the third absorption spectrogram to obtain the absorption spectrogram for reference for concentration calculation comprises: calculating a sum of the second absorption spectrogram and the third absorption spectrogram, and calculating a ratio of the first absorption spectrogram to the sum to obtain the absorption spectrogram for reference for concentration calculation; or calculating a first difference between the first absorption spectrogram and the second absorption spectrogram, and calculating a second difference between the first difference and the third absorption spectrogram to obtain the absorption spectrogram for reference for concentration calculation;
the extracting the characteristic parameter of the absorption spectrogram for reference for concentration calculation comprises: extracting the characteristic parameter of the absorption spectrogram for reference for concentration calculation with a convolutional neural network (CNN); and
the comparing the characteristic parameter of the absorption spectrogram for reference for concentration calculation with the characteristic parameter of the standard absorption spectrogram for each of the standard chlorine gases of the different concentrations comprises: making compensation for the characteristic parameter of the absorption spectrogram for reference for concentration calculation with a characteristic parameter deviation caused by background noise to obtain a compensated characteristic parameter of the absorption spectrogram for reference for concentration calculation; and comparing the compensated characteristic parameter of the absorption spectrogram for reference for concentration calculation with the characteristic parameter of the standard absorption spectrogram for each of the standard chlorine gases of the different concentrations.

11. The working method of the UV-DOAS and OP based long-distance detection device for the chlorine gas according to claim 9, wherein in the UV-DOAS and OP based long-distance detection device for the chlorine gas, the UV focusing module comprises a main optical path mirror, an off-axis parabolic mirror, and a bypass optical path mirror;
the main optical path mirror is configured to reflect the UV light to the off-axis parabolic mirror;
the off-axis parabolic mirror is configured to focus the UV light, and project the resulting collimated UV light to the bypass optical path mirror or the multi-point CCR array; and
the bypass optical path mirror is configured to reflect the resulting collimated UV light to the reference gas cell module.

12. The working method of the UV-DOAS and OP based long-distance detection device for the chlorine gas according to claim 11, wherein in the UV-DOAS and OP based long-distance detection device for the chlorine gas, the reference gas cell module comprises a reference gas cell, a first UV filter, and a reference gas cell retroreflector, wherein the first UV filter and the reference gas cell retroreflector are provided in the reference gas cell; the reference gas cell is filled with the environmental gas; the first UV filter is configured to filter the resulting collimated UV light, and project first filtered collimated UV light to the environmental gas; and the reference gas cell retroreflector is configured to reflect the collimated UV light penetrating the environmental gas to the UV spectrometer; and
the UV-DOAS and OP based long-distance detection device for the chlorine gas further comprises: an UV filter module provided between the UV focusing module and the multi-point CCR array; the UV filter module comprises a second UV filter; and the second UV filter is configured to filter the resulting collimated UV light, and project second filtered collimated UV light to the multi-point CCR array.

13. The working method of the UV-DOAS and OP based long-distance detection device for the chlorine gas according to claim 9, wherein in the UV-DOAS and OP based long-distance detection device for the chlorine gas, the multi-point CCR array comprises a plurality of CCR arrays located at different positions; the UV-DOAS and OP based long-distance detection device for the chlorine gas further comprises: a multi-point angular adjustment mirror provided between the UV focusing module and the multi-point CCR array; and the multi-point angular adjustment mirror is configured to reflect the resulting collimated UV light to a CCR array at a predetermined position, wherein the CCR array at the predetermined position is a CCR array of the plurality of CCR arrays located at the different positions.

14. The working method of the UV-DOAS and OP based long-distance detection device for the chlorine gas according to claim 13, wherein the UV-DOAS and OP based long-distance detection device for the chlorine gas further comprises an auxiliary aiming module; wherein the auxiliary aiming module comprises an infrared light source and an aiming telescope;
the infrared light source is configured to generate infrared light, and project the infrared light to the UV focusing module;
the UV focusing module is configured to focus the infrared light, and project resulting collimated infrared light to the multi-point angular adjustment mirror;
the multi-point angular adjustment mirror is configured to reflect the collimated infrared light to the multi-point CCR array; and
the aiming telescope is configured to observe whether the multi-point CCR array comprises a red spot to adjust a position of the multi-point angular adjustment mirror and a position of the multi-point CCR array.

15. The working method of the UV-DOAS and OP based long-distance detection device for the chlorine gas according to claim 12, wherein the UV-DOAS and OP based long-distance detection device for the chlorine gas further comprises an integrated fiber-optic transceiving module; wherein the integrated fiber-optic transceiving module is connected to the UV light source, the UV focusing module, and the UV spectrometer;
the integrated fiber-optic transceiving module is configured to project the UV light generated by the UV light source to the UV focusing module and the UV spectrometer; the reference gas cell retroreflector is configured to reflect the collimated UV light penetrating the environmental gas to the bypass optical path mirror; the bypass optical path mirror is configured to reflect the collimated UV light penetrating the environmental gas to the off-axis parabolic mirror; the off-axis parabolic mirror is configured to reflect the collimated UV light penetrating the environmental gas to the main optical path mirror; the main optical path mirror is configured to project the collimated UV light penetrating the environmental gas to the integrated fiber-optic transceiving module; and the integrated fiber-optic transceiving module is configured to project the collimated UV light penetrating the environmental gas to the UV spectrometer; and
the multi-point CCR array is configured to reflect the collimated UV light penetrating the to-be-detected chlorine gas to the second UV filter; the second UV filter is configured to project the collimated UV light penetrating the to-be-detected chlorine gas to the off-axis parabolic mirror; the off-axis parabolic mirror is configured to reflect the collimated UV light penetrating the to-be-detected chlorine gas to the main optical path mirror; the main optical path mirror is configured to project the collimated UV light penetrating the to-be-detected chlorine gas to the integrated fiber-optic transceiving module; and the integrated fiber-optic transceiving module is configured to project the collimated UV light penetrating the to-be-detected chlorine gas to the UV spectrometer.

16. The working method of the UV-DOAS and OP based long-distance detection device for the chlorine gas according to claim 15, wherein in the UV-DOAS and OP based long-distance detection device for the chlorine gas, the UV filter module further comprises an adjustment component; the adjustment component is in driving connection with the second UV filter; and the adjustment component is configured to adjust a position of the second UV filter and an angle of the second UV filter, such that an optical path of reflected light of the resulting collimated UV light projected to the second UV filter does not coincide with an optical path of the collimated UV light penetrating the to-be-detected chlorine gas and projected to the second UV filter.

17. The working method of the UV-DOAS and OP based long-distance detection device for the chlorine gas according to claim 9, wherein in the UV-DOAS and OP based long-distance detection device for the chlorine gas, the reference gas cell module is filled with the standard chlorine gas;
the UV light source is configured to generate the UV light, and project the UV light to the UV focusing module and the UV spectrometer;
the UV focusing module is configured to focus the UV light, and project the resulting collimated UV light to the reference gas cell module;
the reference gas cell module is configured to reflect collimated UV light penetrating the standard chlorine gas to the UV spectrometer;
the UV spectrometer is configured to generate a fourth absorption spectrogram for the UV light and a fifth absorption spectrogram for the collimated UV light penetrating the standard chlorine gas; and
the processor is configured to perform calculation on the fourth absorption spectrogram and the fifth absorption spectrogram to obtain a calibration-reference absorption spectrogram, extract a characteristic parameter of the calibration-reference absorption spectrogram, and compare the characteristic parameter of the calibration-reference absorption spectrogram with the characteristic parameter of the standard absorption spectrogram for the standard chlorine gas to determine a characteristic parameter deviation caused by background noise.

18. The working method of the UV-DOAS and OP based long-distance detection device for the chlorine gas according to claim 11, wherein the performing the calculation on the first absorption spectrogram, the second absorption spectrogram, and the third absorption spectrogram to obtain the absorption spectrogram for reference for concentration calculation comprises: calculating a sum of the second absorption spectrogram and the third absorption spectrogram, and calculating a ratio of the first absorption spectrogram to the sum to obtain the absorption spectrogram for reference for concentration calculation; or calculating a first difference between the first absorption spectrogram and the second absorption spectrogram, and calculating a second difference between the first difference and the third absorption spectrogram to obtain the absorption spectrogram for reference for concentration calculation;
the extracting the characteristic parameter of the absorption spectrogram for reference for concentration calculation comprises: extracting the characteristic parameter of the absorption spectrogram for reference for concentration calculation with a CNN; and
the comparing the characteristic parameter of the absorption spectrogram for reference for concentration calculation with the characteristic parameter of the standard absorption spectrogram for each of the standard chlorine gases of the different concentrations comprises: making compensation for the characteristic parameter of the absorption spectrogram for reference for concentration calculation with a characteristic parameter deviation caused by background noise to obtain a compensated characteristic parameter of the absorption spectrogram for reference for concentration calculation; and comparing the compensated characteristic parameter of the absorption spectrogram for reference for concentration calculation with the characteristic parameter of the standard absorption spectrogram for each of the standard chlorine gases of the different concentrations.

19. The working method of the UV-DOAS and OP based long-distance detection device for the chlorine gas according to claim 12, wherein the performing the calculation on the first absorption spectrogram, the second absorption spectrogram, and the third absorption spectrogram to obtain the absorption spectrogram for reference for concentration calculation comprises: calculating a sum of the second absorption spectrogram and the third absorption spectrogram, and calculating a ratio of the first absorption spectrogram to the sum to obtain the absorption spectrogram for reference for concentration calculation; or calculating a first difference between the first absorption spectrogram and the second absorption spectrogram, and calculating a second difference between the first difference and the third absorption spectrogram to obtain the absorption spectrogram for reference for concentration calculation;
the extracting the characteristic parameter of the absorption spectrogram for reference for concentration calculation comprises: extracting the characteristic parameter of the absorption spectrogram for reference for concentration calculation with a CNN; and
the comparing the characteristic parameter of the absorption spectrogram for reference for concentration calculation with the characteristic parameter of the standard absorption spectrogram for each of the standard chlorine gases of the different concentrations comprises: making compensation for the characteristic parameter of the absorption spectrogram for reference for concentration calculation with a characteristic parameter deviation caused by background noise to obtain a compensated characteristic parameter of the absorption spectrogram for reference for concentration calculation; and comparing the compensated characteristic parameter of the absorption spectrogram for reference for concentration calculation with the characteristic parameter of the standard absorption spectrogram for each of the standard chlorine gases of the different concentrations.

20. The working method of the UV-DOAS and OP based long-distance detection device for the chlorine gas according to claim 13, wherein the performing the calculation on the first absorption spectrogram, the second absorption spectrogram, and the third absorption spectrogram to obtain the absorption spectrogram for reference for concentration calculation comprises: calculating a sum of the second absorption spectrogram and the third absorption spectrogram, and calculating a ratio of the first absorption spectrogram to the sum to obtain the absorption spectrogram for reference for concentration calculation; or calculating a first difference between the first absorption spectrogram and the second absorption spectrogram, and calculating a second difference between the first difference and the third absorption spectrogram to obtain the absorption spectrogram for reference for concentration calculation;
the extracting the characteristic parameter of the absorption spectrogram for reference for concentration calculation comprises: extracting the characteristic parameter of the absorption spectrogram for reference for concentration calculation with a CNN; and
the comparing the characteristic parameter of the absorption spectrogram for reference for concentration calculation with the characteristic parameter of the standard absorption spectrogram for each of the standard chlorine gases of the different concentrations comprises: making compensation for the characteristic parameter of the absorption spectrogram for reference for concentration calculation with a characteristic parameter deviation caused by background noise to obtain a compensated characteristic parameter of the absorption spectrogram for reference for concentration calculation; and comparing the compensated characteristic parameter of the absorption spectrogram for reference for concentration calculation with the characteristic parameter of the standard absorption spectrogram for each of the standard chlorine gases of the different concentrations.
